(19) United States
(12) Patent Application Publication
(10) Pub. No.: US 2014/0144664 A1
(43) Pub. Date: May 29, 2014

(54) PORTABLE MACHINE TOOL

(71) Applicant: ROBERT BOSCH GMBH, Stuttgart (DE)

(72) Inventors: Rudolf Fuchs, Neuhausen (DE); Florian Bantle, Gruibingen (DE)

(73) Assignee: ROBERT BOSCH GMBH, Stuttgart (DE)

(21) Appl. No.: 14/076,347

(22) Filed: Nov. 11, 2013

(30) Foreign Application Priority Data
Nov. 28, 2012 (DE) 10 2012 221 758.4

(51) Int. Cl. B25F 5/00

(52) U.S. Cl. CPC B25F 5/00
USPC 173/216

(57) ABSTRACT

A portable machine tool has at least one drive motor, at least one gearbox unit, at least one connecting drive train unit, and at least one actuating element. The at least one connecting drive train unit is configured to transmit a force from the at least one drive motor to the at least one gearbox unit. The at least one connecting drive train unit is also configured to bypass the at least one actuating element.

This application claims priority under 35 U.S.C. §119 to patent application no. DE 10 2012 221 758.4, filed on Nov. 28, 2012 in Germany, the disclosure of which is incorporated herein by reference in its entirety.

### BACKGROUND

Commercially available cordless machine tools in pistol form have an upper housing part on which a tool holder unit is disposed. Behind the tool holder unit are disposed a gearbox unit for a drive mechanism of a tool and a drive motor for a drive mechanism of the gearbox unit.

### SUMMARY

A portable machine tool, in particular a cordless machine tool, having at least one drive motor, at least one gearbox unit, at least one connecting drive train unit for a force transmission from the drive motor to the gearbox unit, and at least one actuating element, wherein the connecting drive train unit bypasses the actuating element, is proposed.

By a “portable machine tool” should be understood, in particular, a machine tool which can be guided with one or with two hands of an operator and, in particular, is different from a fixedly mounted machine tool. By a cordless machine tool should be understood, in particular, a portable machine tool which is supplied with current by means of an accumulator and/or a battery and which is preferably guided with one hand, wherein, for stabilization of the cordless machine tool during use, a two-handed guidance can be provided. For example, the cordless machine tool can be configured as a cordless drill, a cordless hammer drill, a cordless percussion drill, a cordless impact wrench or, preferably, as a cordless screwdriver. Preferably, the portable machine tool is configured in a pistol form. By a “pistol form” should be understood, in particular, a form of the portable machine tool comprising a handle, in which the portable machine tool can be guided with one hand by the handle and in which operation of the actuating element can be carried out with fingers of a hand gripping the handle, without surrendering a grip for guidance of the portable machine tool. By an “actuating element” should be understood, in particular, an element by means of which a function setting of a portable machine tool, in particular of a cordless machine tool, can be made, in particular a switching on or off or a setting of power values of the cordless machine tool. Preferably, the actuating element is configured as a pressure switch, and particularly preferably, as a trigger switch. In principle, the actuating element can also be otherwise configured, for example as a rotary switch or as a touch display. In a configuration of the portable machine tool in pistol form, the actuating element is preferably disposed on the upper housing part or on the handle directly adjacent to the upper housing part. By a “trigger switch” should be understood, in particular, a switch configured in the form of a gun trigger, which switch is actuated with at least one finger and, after a certain pressure threshold is exceeded, a pressure on the trigger switch effects a function setting, wherein, after the pressure threshold is exceeded, the function setting can be configured such that it is variable in line with changes in pressure. In particular, the drive motor is configured to drive a tool mounted in the tool holder unit. Preferably, the drive is formed by an electric motor, and particularly preferably, by a brushless direct-current motor (BLDC motor), which is supplied with current in particular by an accumulator of a cordless machine tool.

By a “connecting drive train unit” should be understood, in particular, a unit having at least one substantially rod-shaped connecting drive train, preferably rotatably mounted, for force transmission, which connecting drive train unit at one end is connected to the drive motor and is driven by the latter and at a further end is connected to the tool holder unit and transmits thereto a force of the drive motor. In the force flux direction from the drive motor to the tool holder unit, in front of or behind the connecting drive train can be arranged a gearbox unit, this being preferably disposed between the connecting drive train and the tool holder unit. The connecting drive train unit transmits, in particular, forces from the drive motor to the gearbox unit in order to drive the tool holder unit and/or to drive an insert tool accommodated in the tool holder unit. By “bypasses” should be understood, in particular, that, particularly due to a position of the at least one actuating element on the portable machine tool, a path of the force transmission from the drive motor to the tool holder unit turns out to be longer than a path of the force transmission given a hypothetical course of the connecting drive train unit through the position of the actuating element on the portable machine tool, wherein the connecting drive train, given the hypothetical course of the connecting drive train unit through the position of the actuating element on the portable machine tool, runs, in particular, fully within the housing of the portable machine tool, apart from a passage through a possible actuating finger enclosure. Preferably, the connecting drive train unit is arranged at least partially separated from the actuating element by a housing of the portable machine tool. In particular, viewed in a machining direction, the drive motor is disposed at least partially in front of the actuating element, the gearbox unit is disposed at least partially after the actuating element, and preferably the actuating element is disposed fully in a region between the drive motor and the actuating element. Preferably, the connecting drive train unit runs at least substantially parallel to the center axis of the tool holder unit and parallel to a longitudinal extent of an actuating finger enclosure, in which the actuating element is disposed. Preferably, the gearbox unit and the drive motor are arranged such that a shortest connecting line, disposed within the portable machine tool, between the gearbox unit and the drive motor deviates from a straight line. In particular, a compact portable machine tool and a highly flexible arrangement of the actuating element can be achieved.

In addition, a pistol grip is proposed. By “a pistol grip” should be understood, in particular, a handle protruding at least substantially perpendicularly from an upper housing part, comprising the tool holder unit, for a one-handed guidance of the portable machine tool, wherein a user, with one or more fingers of one hand with which he clasps the pistol grip for the guidance of the portable machine tool, can actuate an actuating element of the cordless machine tool without surrendering a grip around the pistol grip. By “at least substantially perpendicularly” should be understood, in particular, that an angle between the pistol grip and the upper housing part deviates maximally by twenty, advantageously maximally by ten, and preferably maximally by one degree from 90 degrees. In particular, the pistol grip can protrude from the upper housing part at an angle of 90 degrees. In particular, advantageous grip ergonomics can be achieved.

It is further proposed that the connecting drive train unit runs at least substantially above the actuating element. By the connecting drive train unit “runs at least substantially above the actuating element” should be understood, in particular, that the connecting drive train unit is disposed on a side of the actuating element which is facing toward the top side of the portable machine tool and is facing away from the handle, and that at least sixty, advantageously at least eighty, and preferably one hundred percent of a longitudinal extent of the connecting drive train unit is disposed in a region above a projection of the actuating element in a direction perpendicular to a height direction of the actuating element. In principle, the connecting drive train unit can also bypass the actuating element beneath it, to the left of it or to the right of it. In particular, a compact portable machine tool can be achieved.

In addition, a tool holder unit having a center axis running at least through a surrounding area of the actuating element is proposed. By a “tool holder unit” should be understood, in particular, a unit of the portable machine unit which is configured to receive and fasten an insert tool, for example a bit of a screwdriver or a drill bit. In particular, the tool holder unit has for this purpose an advantageously at least substantially cylindrical receiving region for the tool. The tool holder unit is disposed, in particular, on an upper housing of a cordless machine tool. By a “center axis of the tool holder unit” should be understood, in particular, an infinitely extended straight line running through the middle of the receiving region for the tool in a direction of orientation of a received tool. In particular, the center axis of the tool holder unit corresponds to a force action line of the portable machine tool. By a “surrounding area” should be understood, in particular, an area around the actuating element which is bounded by a distance of maximally 5 mm from the actuating element. As a result of the disclosed configuration of the portable machine tool, in particular an improved guidance of a portable machine tool and improved grip ergonomics can be achieved.

It is further proposed that the center axis of the tool holder unit runs through the actuating element. In particular, an improved guidance of a portable machine tool and improved grip ergonomics can be achieved.

In addition, an actuating finger enclosure, within which an actuating element is disposed, is proposed. By an “actuating finger enclosure” should be understood, in particular, a space bounded by at least three sides of a housing of a cordless machine tool, which space is configured to receive at least one finger of an operator of the cordless machine tool and to provide at least one guide region for the finger during actuation of the actuating element, as well as, preferably, additionally to protect the finger from possible injuries, in particular caused by material fragments which might be flying around during use of the portable machine tool or by slippage of the portable machine tool. In particular, an advantageous guidance and a protection of the finger during actuation of the actuating element can be achieved.

It is further proposed that the actuating finger enclosure is configured closed on at least four sides. Preferably, the actuating finger enclosure is bounded and closed on one side by a connecting web. In particular, the side bounded by the connecting web is formed by a side of the actuating finger enclosure which is situated in a ventral direction. By a “ventral direction” should be understood, in particular, a direction running perpendicular to the center axis of the tool holder unit and along which the handle substantially extends. In particular, an advantageous guidance of the finger upon contact against the actuating element can be achieved.

It is further proposed that the actuating finger enclosure has a height extent of at least 2 cm. By a “height extent” should be understood, in particular, an extent of the actuating finger enclosure in a direction which runs perpendicular to an actuating direction of the actuating element and in which, upon contact of a finger against the actuating element, a finger width extends. In particular, the actuating finger enclosure has a height extent which allows the actuating element to be actuated with two fingers. In particular, a secure guidance of a portable machine tool and a secure actuation of the actuating element can be achieved.

In addition, a handle, within which the drive motor is at least substantially disposed, is proposed. By “at least substantially disposed within the handle” should be understood, in particular, that the drive motor lies at least with seventy, advantageously at least with ninety, and particularly preferably with one hundred percent of its volume within the handle. Preferably, the handle is formed by a pistol grip. As a result of the arrangement of the drive motor in the handle, an improved guidance of a portable machine tool and improved grip ergonomics can be achieved.

It is further proposed that the drive motor is disposed at least partially in a region which, viewed from the tool holder unit, is situated behind the actuating element. In particular, the drive motor is configured to drive a tool mounted in the tool holder unit. Preferably, the drive motor is formed by an electric motor, and particularly preferably by a brushless direct-current motor (BLDC motor), which is supplied with current, in particular, by an accumulator of a cordless machine tool. By the drive motor “is disposed at least partially in a region which, viewed from the tool holder unit, is situated behind the actuating element” should be understood, in particular, that the drive motor is disposed at least partially in a region of the portable machine tool which lies on a projection of the actuating element that runs parallel to the center axis and extends in a direction facing away from the tool holder unit. In particular, an improved guidance of a portable machine tool and improved grip ergonomics can be achieved.

In addition, at least one angle gear unit, which connects the connecting drive train unit to the drive motor, is proposed. By an “angle gear unit” should be understood, in particular, a gearbox which changes a rotary motion at least in one direction. In particular, the angle gear unit is configured to connect a drive motor disposed in the handle, which drive motor is oriented at least substantially in a direction perpendicular to the center axis of the tool holder unit, to a connecting drive train unit running at least substantially parallel to the center axis and to transmit a rotary motion of the output shaft of the drive motor to the connecting drive train unit. In particular, an advantageously space-saving and ergonomic positioning of the drive motor can be achieved with simple configuration.

The disclosed portable machine tool should not be confined to the application and embodiment described above. In particular, the disclosed portable machine tool, in order to fulfill a working method described herein, can have a number of individual elements, parts and units which differs from a number stated herein.

### BRIEF DESCRIPTION OF THE DRAWINGS

Further advantages emerge from the following drawing description. In the drawing, six illustrative embodiments of the disclosure are represented. The drawing, the description and the claims contain numerous features in combination. The person skilled in the art will expediently consider the features also individually and combine them into sensible further combinations.

FIG. 1 shows a disclosed portable machine tool, configured as a cordless machine tool, in a pistol form,

FIG. 2 shows an alternative embodiment of a portable machine tool, having a grip protection for the handle,

FIG. 3 shows an alternative embodiment of a portable machine tool, having a drive motor, with internal fan, disposed in a handle,

FIG. 4 shows a further alternative embodiment of a portable machine tool, having a drive motor, with internal fan, disposed in a handle,

FIG. 5 shows a further alternative embodiment of a portable machine tool, having a drive motor, with internal fan, disposed in a handle, and

FIG. 6 shows an alternative embodiment of a portable machine tool, having a drive motor, with external fan, disposed in a handle.

### DETAILED DESCRIPTION

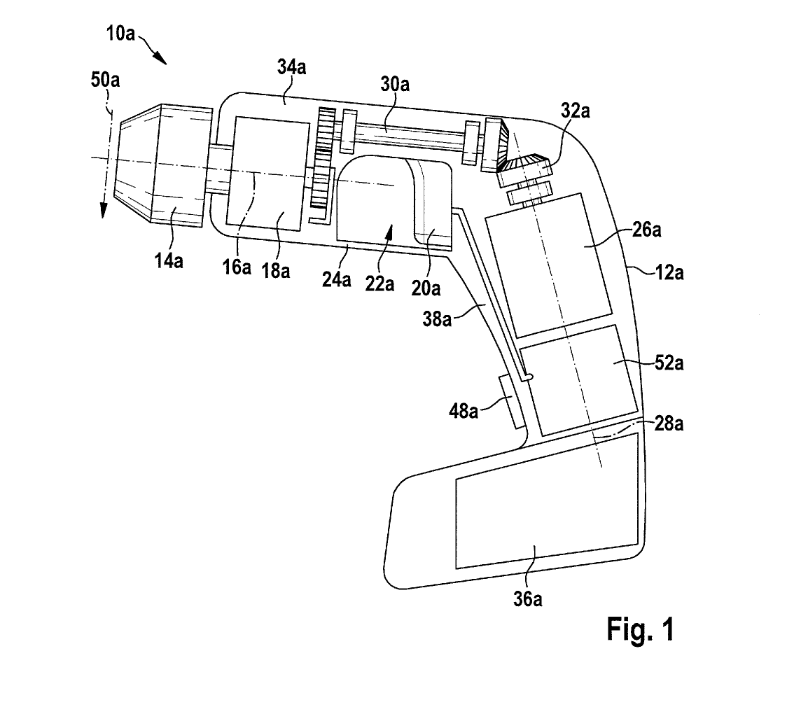

FIG. 1 shows a disclosed portable machine tool, which is configured as a cordless machine tool 10a. The cordless machine tool 10a is configured as a cordless screwdriver. The cordless machine tool 10a is configured in a pistol form and has a handle 38a by which the cordless machine 10a is gripped for usage and guidance. The cordless machine tool 10a is configured for one-handed guidance by gripping of the handle 38a, wherein, in principle, a second hand of a user can be used to guide the cordless machine tool 10a, for example to grip an upper housing part 34a. The handle 38a is realized as a pistol grip 12a. In the shown example, the cordless machine tool 10a comprises an actuating element 20a and a tool holder unit 14a, which latter is configured to receive a screw for screw-in purposes. In the handle 38a, a power supply unit 36a formed by an accumulator is disposed in a lower region, which, in normal operation, is facing toward a floor and facing away from the upper housing part 34a. In alternative embodiments, instead of a power supply unit 36a configured as an accumulator, for example, a power supply unit 36a configured as a battery can be used. The lower region, in which the power supply unit 36a is disposed, is configured so as to project forward, viewed in a direction toward the tool holder. Above the projecting, lower region, a further actuating element 48a, which cooperates with the actuating element 20a in order to switch on and/or adjust the cordless machine tool 10a, is disposed on the handle 38a. In alternative embodiments, the further actuating element 48a can be dispensed with.

A center axis 16a of the tool holder unit 14a runs through the actuating element 20a and thus through a surrounding area of the actuating element 20a. In alternative embodiments of the cordless machine tool 10a, the center axis 16a of the tool holder unit 14a can also run, for example, at a distance of 5 mm above an upper end of the actuating element 20a or at a lesser distance therefrom. The center axis 16a of the tool holder unit 14a has a distance from a center point of the actuating element 20a, and two-thirds of a longitudinal extent of the actuating element 20a extend on a side of the center axis 16a which is facing toward the handle 38a and which in normal operation is facing toward the floor. The actuating element 20a thus extends for the most part on a side of the center axis 16a which is facing toward the handle 38a and which, in normal operation, is facing toward the floor. Due to such a course of the center axis 16a, advantageous ergonomics can be achieved in respect of actuation of the actuating element 20a and guidance of the cordless machine tool 10a, since a force action line of the cordless machine tool 10a, which runs along the center axis 16a of the tool holder unit 14a, runs through a hand of a user and beneath at least one actuating finger of the user, whereby unwanted torques on the hand can be avoided.

The cordless machine tool 10a has an actuating finger enclosure 22a, in which the actuating element 20a is disposed. The center axis 16a of the tool holder unit 14a thus also runs through the actuating finger enclosure 22a. The actuating finger enclosure 22a is configured closed on a side running parallel to the center axis 16a and facing toward the handle 38a and is closed there by a connecting web 24a between two sections of the upper housing part 34a. The connecting web 24a is disposed on a side of the center axis 16a of the tool holder unit 14a which, in a normal operating state, is facing toward the floor, and offers a bearing surface for an actuating finger of the user, as well as protection from any sharp edges or splinters in an environment. The actuating finger enclosure 22a has a height extent of 5 cm, whereby an actuation of the actuating element 20a by means of two fingers is possible. The height extent is formed by an extent of the actuating finger enclosure 22a which runs perpendicular to a longitudinal extent of the actuating finger enclosure 22a and substantially perpendicular to the center axis 16a of the tool holder unit 14a, which extent, in a normal operating state of the cordless machine tool 10a, runs parallel to a surface normal of the floor. In principle, the actuating finger enclosure 22a can in alternative embodiments have a lesser height extent, so that the actuating element 20a can be actuated merely with one actuating finger.

The cordless machine tool 10a comprises a drive motor 26a, which is disposed at least partially in a region which, viewed from the tool holder unit 14a, is situated behind the actuating element 20a. Given a projection of the actuating element 20a along a direction leading away from the tool holder unit 14a and running parallel to the center axis 16a, then roughly one half of the drive motor 26a lies within a region intersected by the projection, while a further half extends downward in the direction of the handle 38a, facing, in a normal operating state, toward a floor. The drive motor 26a is disposed within the handle 38a. The center axis 16a of the tool holder unit 14a runs through the drive motor 26a and traverses this in an upper region facing toward a top side of the cordless machine tool 10a. The top side of the cordless machine tool 10a is arranged opposite the handle 38a and facing away from the handle 38a. A motor axis 28a of the drive motor 26a forms an angle of 70 degrees with the center axis 16a of the tool holder unit 14a.

The cordless machine tool 10a further has a connecting drive train unit 30a for force transmission from the drive motor 26a to the tool holder unit 14a, which connecting drive train unit runs at least substantially alongside the actuating finger enclosure 22a. The connecting drive train unit 30a has a rotatably mounted connecting drive train, which at one end is connected to a gearbox and at a further end has a revolving disk with beveled surface, which meshes with an analogously configured revolving disk with beveled surface of an output shaft of the drive motor 26a. The revolving disks form an angle gear unit 32a of the cordless machine tool 10a, which angle gear unit connects the connecting drive train unit 30a to the drive motor 26a. A gearbox unit 18a connects the connecting drive train unit 30a to the tool holder unit 14a and is configured to match a rotation speed of the output shaft of the drive motor 26a to an intended rotation speed of the tool holder unit 14a by means of a constant and/or a variable transmission ratio. The gearbox unit 18a can be configured, for example, as a planetary gear, wherein the connecting drive train unit 30a drive, for example, a sun wheel or planet wheel, a hollow wheel or a planet carrier. The cordless machine tool 10a can in alternative embodiments be configured, for example, as a cordless impact wrench or as a cordless percussion drill, and the gearbox unit 18a for this comprise, for example, instead of or additionally to a screwdriver gearbox, a gearbox having an impact wrench mechanism, a gearbox having a notched disk for percussion drilling, or a gearbox having a hammer mechanism.

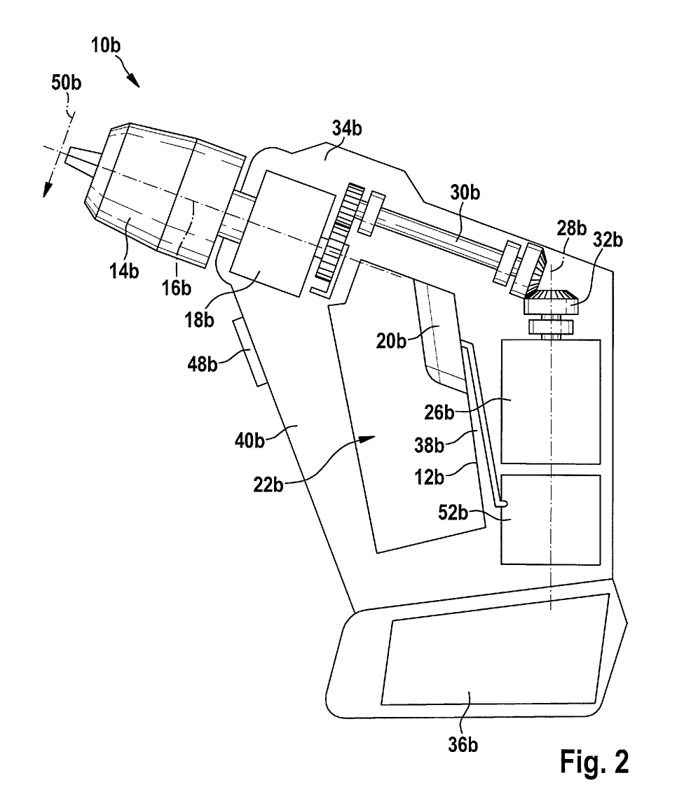

In FIGS. 2 to 6, five further illustrative embodiments of the disclosure are shown. The following descriptions and the drawings substantially confine themselves to the differences between the illustrative embodiments, wherein, with respect to identically labeled parts, in particular with regard to parts having the same reference symbols, reference is fundamentally also made to the drawings and/or the description of the other illustrative embodiments, in particular of FIG. 1. In order to differentiate between the illustrative embodiments, the letter a is placed after the reference symbols of the illustrative embodiment in FIG. 1. In the illustrative embodiments of FIGS. 2 to 6, the letter a is replaced by the letters b to f.

The alternative embodiment of a cordless machine tool 10b in FIG. 2 is substantially identical to the previous illustrative embodiment and differs from this merely by an additional grip protection element 40b, which, starting from the upper housing part 34b, in a normal operating state extends facing toward the floor and, in a direction of view through the housing part 34b along a center axis 16b up to a tool holder unit 14b, is disposed behind a handle 38b configured as a pistol grip 12b. The grip protection element 40b is configured to offer additional protection, during guidance of the cordless machine tool 10b, for a hand of a user which is clasping the handle 38b. A further actuating element 48b for actuation of the cordless machine tool 10b is disposed on the grip protection element 40b.

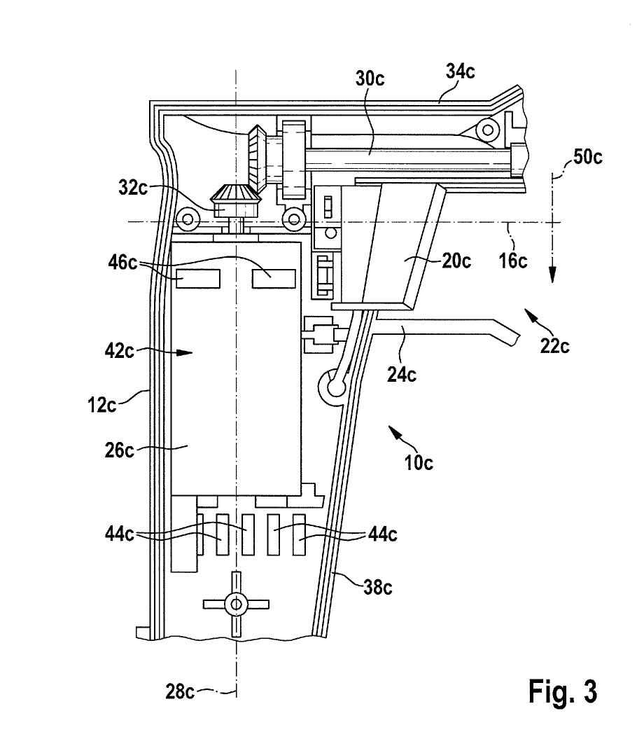

FIG. 3 shows a detail of an alternative cordless machine tool 10c, which is configured as a cordless screwdriver constructed substantially analogously to the previous illustrative embodiments. A center axis 16c of a tool holder unit (not represented in the shown detail) runs through a surrounding area of and, in particular, directly through an actuating element 20c disposed in an actuating finger enclosure 22c. The cordless machine tool 10c comprises a handle 38c, which is configured as a pistol grip 12c and within which a drive motor 26c is disposed, and an upper housing part 34c, in which the actuating finger enclosure 22c is disposed. The actuating finger enclosure 22c is configured such that it is closed by a connecting web 24c in the downward direction, i.e. on a side running parallel to the center axis 16c and facing toward the handle 38c. The drive motor 26c has a diameter of 28 mm and a length of 54 mm, which is more than one and a half times as large as the diameter. The drive motor 26c is configured as a brushless direct-current motor, i.e. as a direct-current motor having an electronic circuit which replaces a mechanical commutator with brushes for commutation to generate a rotating magnetic field from a direct current, which mechanical commutator is otherwise necessary in direct-current motors. The cordless machine tool 10c further comprises a fan unit 42c, which is configured to ventilate and cool the drive motor 26c and is integrated in the drive motor 26c. Via air passage openings 44c disposed on the handle 38c in a region beneath the drive motor 26c, i.e. on a side of the drive motor 26c which is facing away from the upper housing part 34c, the fan unit 42c sucks up air from a space outside the cordless machine tool 10c for cooling of the drive motor 26c. Heated waste air is blown out through further air passage openings 46c, which are disposed radially on an upper region of the drive motor 26c. The fan unit 42c is thus disposed partially in an upper region of the drive motor 26c. In principle, in an alternative embodiment, air can also be sucked up via the further air passage openings 46c and blown out via the air passage openings 44c. The drive motor 26c is cooled from inside by the integrated fan unit 42c. An angle gear unit 32c connects the drive motor 26c to a connecting drive train unit 30c and deflects a force flux from a direction of a motor axis 28c of the drive motor 26c which runs perpendicular to the center axis 16c into a direction of the connecting drive train unit 30c which runs parallel to the center axis 16c. In principle, the motor axis 28c can also form an angle other than ninety degrees with the center axis 16c.

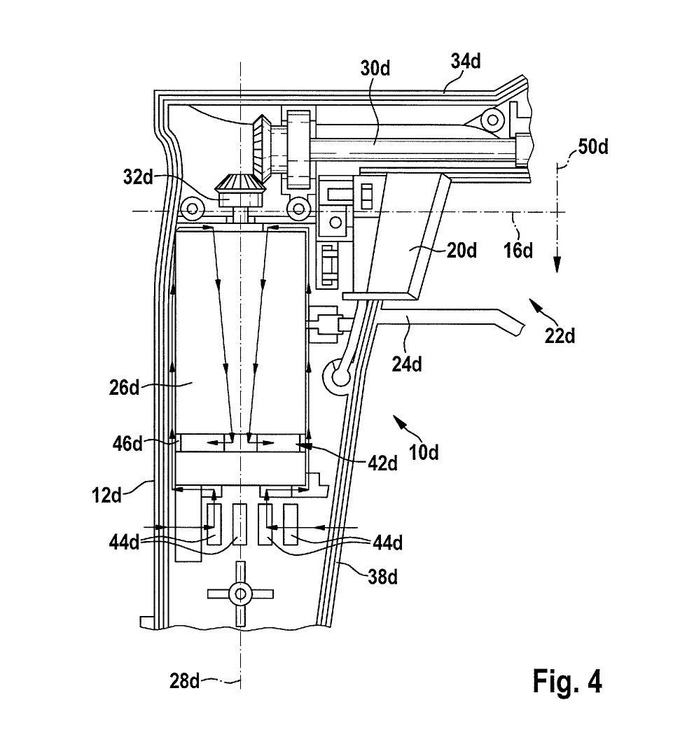

In a further alternative embodiment (FIG. 4) of a cordless machine tool 10d, this is configured substantially analogously to the previous illustrative embodiment with an upper housing part 34d and a handle 38d configured as a pistol grip 12d. In the handle 38d is disposed a drive motor 26d, which is connected by means of an angle gear unit 32d to a connecting drive train unit 30d in the upper housing part 34d, wherein the angle gear unit 32d deflects a force flux from a direction of a motor axis 28d which runs perpendicular to a center axis 16d into a direction of the connecting drive train unit 30d which runs parallel to the center axis 16d. In principle, the motor axis 28d can also form an angle other than ninety degrees with the center axis 16d.

The connecting drive train unit 30d bypasses an actuating element 20d disposed in an actuating finger enclosure 22d in the upper housing part 34d. The drive motor 26d has a diameter of 28 mm and a length of 54 mm, which is more than one and a half times as large as the diameter. The drive motor 26d is configured as a brushless direct-current motor i.e. as a direct-current motor having an electronic circuit which replaces a mechanical commutator with brushes for commutation for generating a rotating magnetic field from a direct current, which mechanical commutator is otherwise necessary in direct-current motors. The cordless machine tool 10d further comprises a fan unit 42d, which is configured to ventilate and cool the drive motor 26d and which is integrated in the drive motor 26d. The fan unit 42d is arranged in a lower region of the drive motor 26d and, via air passage openings 44d disposed on the handle 38d in a region beneath the drive motor 26d, i.e. on a side of the drive motor 26d which is facing away from the upper housing part 34d, sucks up air from a space outside the cordless machine tool 10d for cooling of the drive motor 26d. Heated air is blown out via further air passage openings 46d, which are disposed radially on the drive motor 26d in a lower region. In principle, in an alternative embodiment, air can also be sucked up via the further air passage openings 46d and blown out via the air passage openings 44d. The air sucked up through the air passage openings 44d flows past the outside of the drive motor 26d and thus cools it from outside, and is conducted through the fan unit 42d from above, i.e. from a side facing toward the upper housing part 34d, and through the drive motor 26d for internal cooling thereof, before being blown out through the air passage openings 46d. The drive motor 26d is thus cooled from inside and outside. The air passage openings 44d, 46d are arranged at a suitable distance to the actuating element 20d, so that, if a one-handed guidance of the cordless machine tool 10d is intended, they are not covered by a hand of a user.

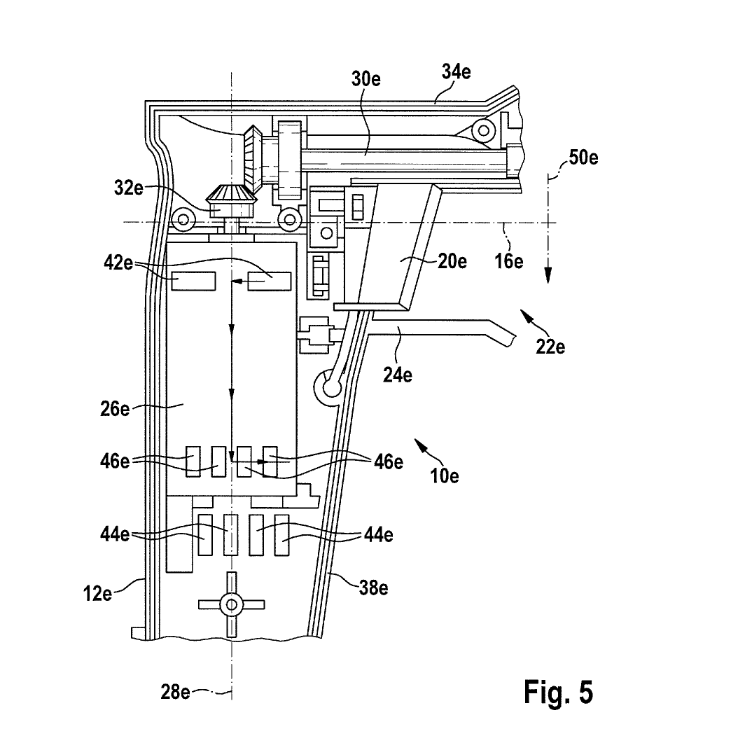

A further alternative embodiment (FIG. 5) of a cordless machine tool 10e is configured substantially analogously to the previous illustrative embodiment. A fan unit 42e for ventilating and cooling a drive motor 26e disposed in a handle 38e configured as a pistol grip 12e is integrated in the drive motor 26e and disposed in an upper region of the drive motor 26e. The fan unit 42e has an air passage opening 44f, which is disposed above the drive motor 26f and, via air passage openings 44e disposed on the handle 38e in a region beneath the drive motor 26e, i.e. on a side of the drive motor 26e which is facing away from an upper housing part 34e, sucks up air from a space outside a cordless machine tool 10e for cooling of the drive motor 26e. Heated air is blown out via further air passage openings 46e, which are disposed radially on the drive motor 26e in a lower region. In principle, in an alternative embodiment, air can also be sucked up via the further air passage openings 46e and blown out via the air passage openings 44e. The air sucked up through the air passage openings 44e flows past the outside of the drive motor 26e and thus cools it from outside, and is conducted through the fan unit 42e from above, i.e. from a side facing toward the upper housing part 34e, and through the drive motor 26e for internal cooling thereof, before being blown out through the air passage openings 46e. The drive motor 26e is thus cooled from inside and outside. The air passage openings 44e, 46e are arranged at a suitable distance to an actuating element 20e, so that, if a one-handed guidance of a cordless machine tool 10e is intended, they are not covered by a hand of a user.

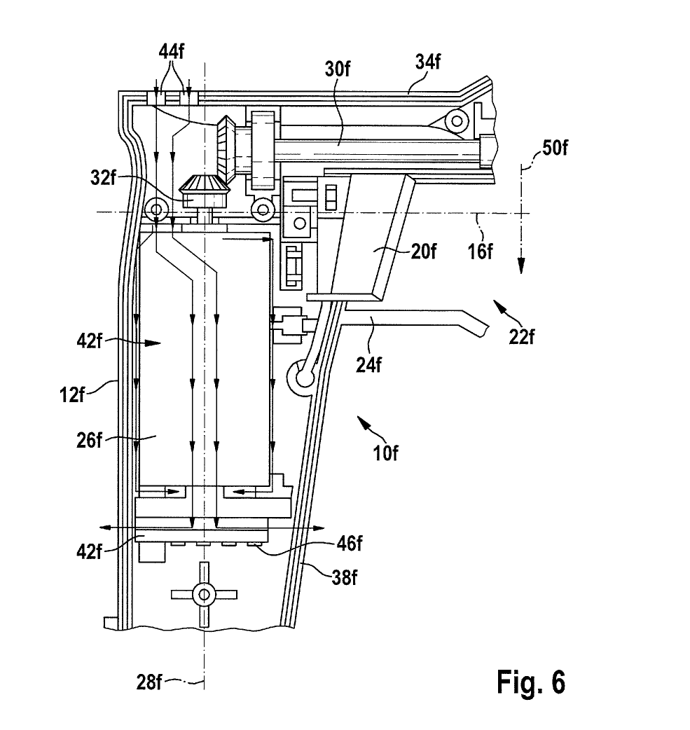

In a further alternative embodiment (FIG. 6) of a cordless machine tool 10f, a fan unit 42f for a drive motor 26f disposed in a handle 38f configured as a pistol grip 12f is disposed outside the drive motor 26f. The fan unit 42f is disposed beneath the drive motor 26f, i.e. is disposed in a region of the handle 38f from which the drive motor 26f will be seen to lie between the region and the upper housing part 34f. Via air passage openings 44f disposed on the handle 38f in a region beneath the drive motor 26f, i.e. on a side of the drive motor 26f which is facing away from an upper housing part 34f, the fan unit 42f sucks up air from a space outside a cordless machine tool 10f for cooling of the drive motor 26f. Heated air is blown out via further air passage openings 46f, which are disposed radially on the drive motor 26f in a lower region. In principle, in an alternative embodiment, air can also be sucked up via the further air passage openings 46f and blown out via the air passage openings 44f. The air sucked up through the air passage openings 44f flows past the outside of the drive motor 26f and thus cools it from outside, and is conducted through the fan unit 42f from above, i.e. from a side facing toward the upper housing part 34f, and through the drive motor 26f for internal cooling thereof, before being blown out through the air passage openings 46f. The drive motor 26f is thus cooled from inside and outside. The air passage openings 44f, 46f are arranged at a suitable distance to an actuating element 20f, so that, if a one-handed guidance of a cordless machine tool 10f is intended, they are not covered by a hand of a user.

What is claimed is:

1. A portable machine tool, comprising:
at least one drive motor;
at least one gearbox unit;
at least one connecting drive train unit configured to transmit a force from the at least one drive motor to the at least one gearbox unit; and
at least one actuating element,
wherein the at least one connecting drive train unit is configured to bypass the at least one actuating element.

2. The portable machine tool according to claim 1, further comprising a pistol grip.

3. The portable machine tool according to claim 1, wherein the at least one connecting drive train unit is configured to run at least substantially above the at least one actuating element.

4. The portable machine tool according to claim 1, further comprising a tool holder unit having a center axis, wherein the tool holder unit is configured so that the center axis runs at least through a surrounding area of the at least one actuating element.

5. The portable machine tool according to claim 4, wherein the tool holder unit is configured so that the center axis runs through the at least one actuating element.

6. The portable machine tool according to claim 1, further comprising:
an actuating finger enclosure,
wherein the at least one actuating element is disposed within the actuating finger enclosure.

7. The portable machine tool according to claim 6, wherein the actuating finger enclosure is configured closed on at least four sides.

8. The portable machine tool at least according to claim 6, wherein the actuating finger enclosure has a height extent of at least 2 cm.

9. The portable machine tool according to claim 4, further comprising:
a handle,
wherein the at least one drive motor is at least substantially disposed within the handle.

10. The portable machine tool according to claim 9, wherein the at least one drive motor is disposed at least partially in a region which, viewed from the tool holder unit, is situated behind the at least one actuating element.

11. The portable machine tool according to claim 1, further comprising at least one angle gear unit configured to connect the at least one connecting drive train unit to the at least one drive motor.

12. The portable machine tool according to claim 1, wherein the portable machine tool is a cordless machine tool.
